(19) United States
(12) Patent Application Publication
(10) Pub. No.: US 2026/0339965 A1
(43) Pub. Date: Oct. 29, 2026

(54) INFORMATION PROCESSING APPARATUS

(71) Applicant: NEC Corporation, Tokyo (JP)

(72) Inventors: Junya KAWAI, Tokyo (JP); Kosei KOBAYASHI, Tokyo (JP); Masahiko TAKAHASHI, Tokyo (JP); Taiga IYOKU, Tokyo (JP)

(73) Assignee: NEC Corporation, Tokyo (JP)

(21) Appl. No.: 19/648,128

(22) Filed: Apr. 15, 2026

(30) Foreign Application Priority Data
Apr. 25, 2025 (JP) 2025-073614

(51) Int. Cl. G06F 16/2457

(52) U.S. Cl. CPC G06F 16/24578

(57) ABSTRACT

An information processing apparatus of the present disclosure includes a search unit that searches for candidate data from data in a database on the basis of evaluation of first relevance between search data and the data stored in the database, a selecting unit that selects selection data from the candidate data on the basis of evaluation of second relevance between the search data and the candidate data, the second relevance being different from the first relevance, and an output unit that outputs the selection data.

### INCORPORATION BY REFERENCE

This application is based upon and claims the benefit of priority from Japanese patent application No. 2025-073614, filed on Apr. 25, 2025, the disclosure of which is incorporated herein in its entirety by reference.

### TECHNICAL FIELD

The present disclosure relates to an information processing apparatus.

### BACKGROUND ART

Patent Literature 1 discloses that, in the case of searching for desired data from data registered in a database, an index representing the relevance between pieces of data is calculated, and pieces of data retrieved based on the index are ranked in order.

Patent Literature 1: WO 2016/157467 A

### SUMMARY

However, when data is searched for based on the relevance between pieces of data, a large number of pieces of data can be retrieved. This causes a problem that it is difficult to select data from among the retrieved data.

Therefore, an example object of the present disclosure is to solve the aforementioned problem that it is difficult to select data from among retrieved data.

An information processing apparatus according to one aspect of the present disclosure is configured to include
a search unit that searches for candidate data from data in a database on the basis of evaluation of first relevance between search data and the data stored in the database,
a selecting unit that selects selection data from the candidate data on the basis of evaluation of second relevance between the search data and the candidate data, the second relevance being different from the first relevance, and
an output unit that outputs the selection data.

Further, an information processing method according to one aspect of the present disclosure is configured to include, by an information processing apparatus,
searching for candidate data from data stored in a database on the basis of evaluation of first relevance between search data and the data stored in the database;
selecting selection data from the candidate data on the basis of evaluation of second relevance between the search data and the candidate data, the second relevance being different from the first relevance,and
outputting the selection data.

Further, a program according to one aspect of the present disclosure is configured to cause an information processing apparatus to execute processing
to search for candidate data from data stored in a database on the basis of evaluation of first relevance between search data and the data stored in the database,
output the selection data.

With the configurations as described above, the present disclosure makes it easy to select data from among retrieved data.

### BRIEF DESCRIPTION OF DRAWINGS

FIG. 1 is a block diagram illustrating an example configuration of an information processing apparatus according to the present disclosure;

FIG. 2 is a flowchart illustrating an example of processing operation by the information processing apparatus according to the present disclosure;

FIG. 3 illustrates an example of processing by the information processing apparatus according to the present disclosure;

FIG. 4 illustrates an example of processing by the information processing apparatus according to the present disclosure;

FIG. 5 illustrates an example of processing by the information processing apparatus according to the present disclosure;

FIG. 6 illustrates an example of processing by the information processing apparatus according to the present disclosure;

FIG. 7 is a block diagram illustrating an example of a hardware configuration of an information processing apparatus according to the present disclosure;

FIG. 8 is a block diagram illustrating an example configuration of the information processing apparatus according to the present disclosure; and

FIG. 9 is a flowchart illustrating an example of processing operation by the information processing apparatus according to the present disclosure.

### EXAMPLE EMBODIMENTS

### First Example Embodiment

A first example embodiment of the present disclosure will be described below with reference to the drawings. Note that the drawings may be relevant to any of the example embodiments.

An information processing apparatus according to the present disclosure is used to search, from data stored in a database, for data that may correspond to search data input by a user and present the data to the user. At this time, in particular, the information processing apparatus searches for candidate data on the basis of first relevance to the search data input by the user, and then selects, from such candidate data, selection data on the basis of second relevance to the search data, and presents it to the user.

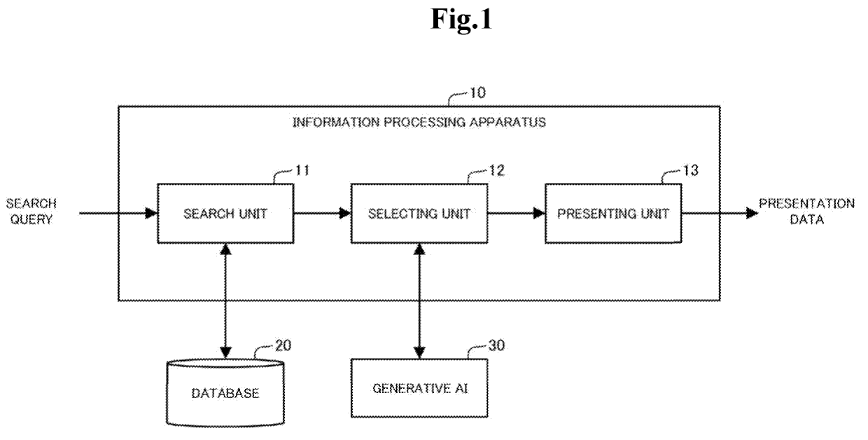

Hereinafter, an example of a configuration and operation of an information processing apparatus 10 according to this example embodiment will be described. The information processing apparatus is configured of one or a plurality of information processing apparatuses each including an arithmetic logic unit and a memory unit. As illustrated in FIG. 1, the information processing apparatus 10 includes a search unit 11, a selecting unit 12, and a presenting unit 13. The respective functions of the search unit 11, the selecting unit 12, and the presenting unit 13 can be implemented by having an arithmetic logic unit execute programs for implementing the respective functions stored in the memory unit. The information processing apparatus 10 is connected, via a network or the like, to a database 20 and a generative AI (Artificial Intelligence) 30.

The database 20 stores therein a large number of pieces of data (for example, any type of data such as text data, image data, and audio data). In particular, in this example embodiment, it is assumed that case data consisting of text data is stored. The case data is, for example, case data relating to various troubles in a company, and is configured such that trouble situations, methods for dealing with the troubles, and contact information are associated with one another. However, the text data stored in the database 20 is not limited to case data. It may be any kind of text data such as Q&A (Question and Answer) data or operation manual data. Moreover, the data stored in the database 20 is not limited to text data, but other types of data will be described in other embodiments.

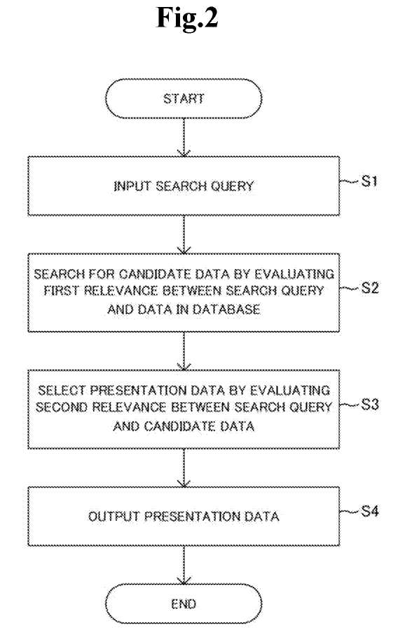

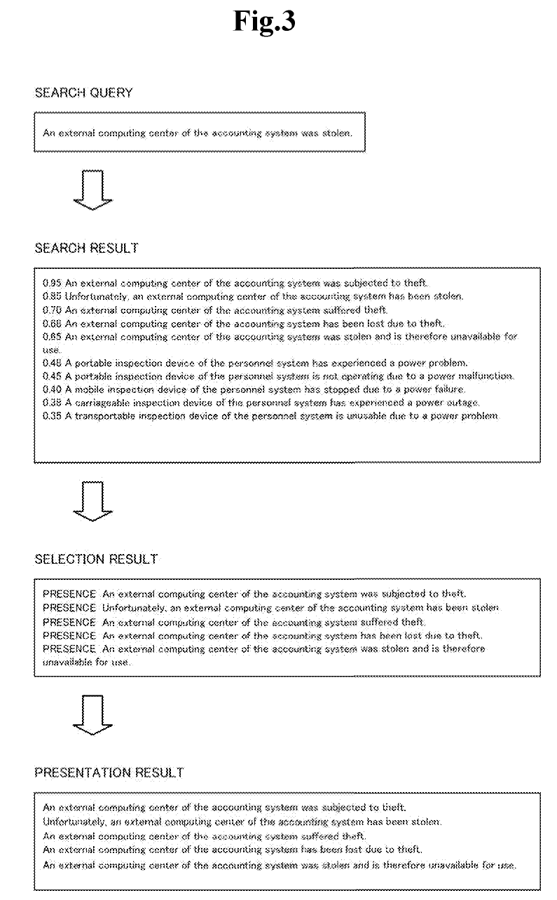

The search unit 11 acquires a search query (search data) input to the information processing apparatus 10 by the user (step S1 in FIG. 2). Here, in this example embodiment, the user inputs a search query consisting of text data relating to a trouble that has occurred in the company, and attempts to acquire, from the database 20, case data that can appropriately correspond to the search query. As an example, the search query is assumed to be text data "An external computing center of the accounting system was stolen" as illustrated in FIG. 3.

Then, the search unit 11 performs search processing for case data corresponding to the search query, from among the case data stored in the database 20. More specifically, the search unit 11 evaluates first relevance between the search query and each piece of case data in the database 20, and extracts case data in the database 20 as candidate data on the basis of such evaluation (step S2 in FIG. 2). In this example embodiment, in particular, as an evaluation index of the first relevance, an evaluation index consisting of continuous numerical values such as a vector similarity between the search query and the case data is used. Accordingly, the search unit 11 converts the search query and each piece of case data in the database 20 into vector representations, calculates the cosine similarity by performing a vector search between the search query and each piece of case data, and evaluates it as a similarity score. Then, the search unit 11 extracts, from the database 20, pieces of case data having high similarity scores as candidate data. As an example, in the search result of FIG. 3, pieces of the case data ranked in the top ten in terms of similarity score that is an evaluation of the first relevance, are extracted as candidate data. In the search result of FIG. 3, the similarity scores are shown on the left side, and to their right, text data that is part of the case data is shown. In this example, the similarity score is calculated to be higher as the search query and the case data are more similar.

The database 20 may store vector representations of the stored case data. As a result, the search unit 11 is able to perform similarity calculation with the search query at high speed. In the example of FIG. 3, the search unit 11 is configured to extract pieces of candidate data whose similarity scores rank up to the top ten. However, any number of pieces of candidate data may be extracted. For example, the number of pieces of candidate data to be extracted may be preset by a user or the system, or may be set according to the content of the search query. For example, the search unit 11 may examine the content of the text data serving as the search query. It may be set that the smaller number of pieces of candidate data are extracted if the content is determined to be of high urgency according to the content. As an example, when the search unit 11 extracts a keyword from the search query for which a degree of urgency has been set, the number of pieces of candidate data to be extracted may be set according to the degree of urgency of the keyword.

Note that while cosine similarity in the vector search between the search query and the case data is cited as the evaluation index of the first relevance in the above description, any similarity calculated by any method may be used. Further, the evaluation index of the first relevance is not limited to the similarity between the search query and the case data, and may be any index as long as it represents the degree of relevance between the search query and the case data. In this case, the evaluation index of the first relevance need not necessarily be represented using continuous values.

The selecting unit 12 evaluates the second relevance between the search query and each piece of the candidate data, and, based on the evaluation, selects presentation data (selection data) from the case data (step S3 in FIG. 2). In this example embodiment, in particular, the possibility that the search data and the candidate data form a pair is used as the evaluation index for the second relevance. Specifically, the possibility that the search data and the candidate data form a pair refers to whether or not there is relevance between the search data and the candidate data such as having the same meaning according to the predetermined criteria, and in this example embodiment, it is assumed that the determination is made by a generative AI 30. Here, the generative AI 30 is a general large language model, and determines whether or not the entered search query and each piece of candidate data are related, and outputs the determination result as an evaluation of the second relevance.

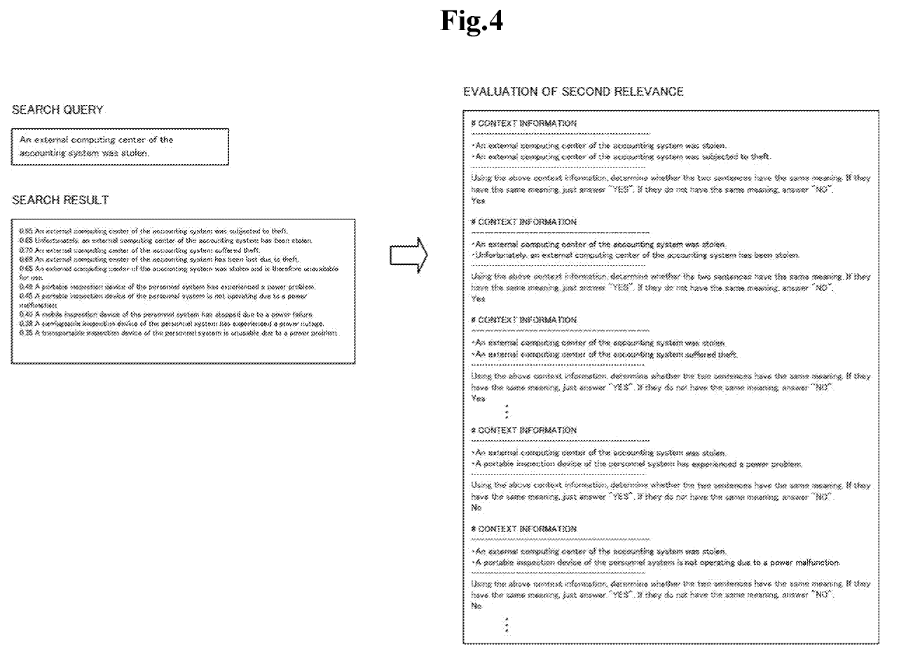

Here, FIG. 4 illustrates an example of processing to evaluate whether or not the search query and the candidate data are relevant, by the selecting unit 12. The selecting unit 12 extracts a search query and each piece of candidate data shown on the left side of FIG. 4 and, as shown on the right side of FIG. 4, generates a prompt (instruction) requesting the generative AI 30 to determine whether or not the search query and the candidate data have the same meaning, that is to say, whether they are relevant to each other. At this time, the selecting unit 12 associates one piece of candidate data with the search query, and generates, for each piece of candidate data, a prompt that requests determination as to whether or not they are relevant. Then, the selecting unit 12 inputs the generated prompt to the generative AI 30 to thereby receive the answer output from the generative AI 30. The example of FIG. 4 illustrate the case where the generative AI 30 answers "Yes" for the candidate data that is determined to be relevant to the search query.

Then, the selecting unit 12 selects, as presentation data, the candidate data determined to be relevant to the search query by the generative AI 30. As an example, as shown in the selection result of FIG. 3, the candidate data that has been determined to be relevant in the evaluation of the second relevance is selected as presentation data. In the selection result of FIG. 3, the left side indicates that relevance is present, and to its right side, text data that is a portion of the selected presentation data is shown.

Here, in the example of the selection results illustrated in FIG. 3, as described above, among the pieces of candidate data whose similarity scores, that is, the first relevance, are in the top ten, pieces of candidate data up to the top five are determined to have the second relevance and are selected as the presentation data. That is to say, in the example of FIG. 3, pieces of candidate data with similarity scores of 0.65 or higher are selected as presentation data, and "0.65 or higher" or "values between 0.65 and 0.48" are set as the boundary values for selection as presentation data. As described above, it can be said that the selecting unit 12 also determines the boundary value of the similarity score that is the first relevance.

Note that, in the above description, as the evaluation index of the second relevance, whether or not relevance is present, that is, the search query and the candidate data form a pair, or, have the same meaning, has been cited. However, it only needs to be an evaluation index different from that of the first relevance, and any kind of relevance evaluation index may be used. It is preferable that an evaluation index of the second relevance is expressed not as a continuous value like the first relevance, but as a binary value indicating presence or absence.

The presenting unit 13 (output unit) outputs, to the user, the presentation data selected as described above (step S4 in FIG. 2). Specifically, the presenting unit 13 presents the presentation data to the user by, for example, displaying a list of the presentation data on the screen of the information processing terminal operated by the user, reading out the information by voice, or passing the result to another application. In the example of FIG. 3, as shown in the presentation result, the presentation data selected by further narrowing down the candidate data to five pieces is presented.

As described above, according to the present disclosure, the user can obtain presentation data that appropriately corresponds to the search query. At this time, in particular, since the number of pieces of presentation data is narrowed down, it becomes easier to select more appropriate data from the presentation data.

Note that the presenting unit 13 may also be configured to, when any one of the pieces of presentation data is selected by the user, read out from the database 20 other data associated with the case data corresponding to the presentation data and present the read-out data to the user. For example, when the presentation data represents a trouble situation that is part of the case data, associated data such as methods for handling the trouble and contact information may be presented to the user.

### Second Example Embodiment

Next, a second example embodiment of the present disclosure will be described with reference to the drawings. Note that the drawings may be relevant to any of the example embodiments.

An information processing apparatus 10 according to this example embodiment has the same configuration as that of the first example embodiment described above. In addition, the information processing apparatus 10 has the following configuration. Hereinafter, a configuration different from the above will mainly be described.

In this example embodiment, when evaluating the second relevance between the search query and the candidate data, the selecting unit 12 of the information processing apparatus 10 evaluates the second relevance not for all of the candidate data searched for by the search unit 11 but for a limited number of pieces of candidate data. For example, the selecting unit 12 examines the content of the text data that is a search query and, if the content is determined to be of high urgency according to said content, the selecting unit 12 determines a smaller number of pieces of candidate data as the urgency is higher, and evaluates the second relevance to the search query only for the determined number of pieces of candidate data. As an example, when the selecting unit 12 extracts, from the search query, a keyword for which a degree of urgency is set, it may determine the number of pieces of candidate data to be evaluated according to the degree of urgency set for the keyword. However, the selecting unit 12 may evaluate the second relevance to the search query only for the number of pieces of candidate data set in advance by the user or the system.

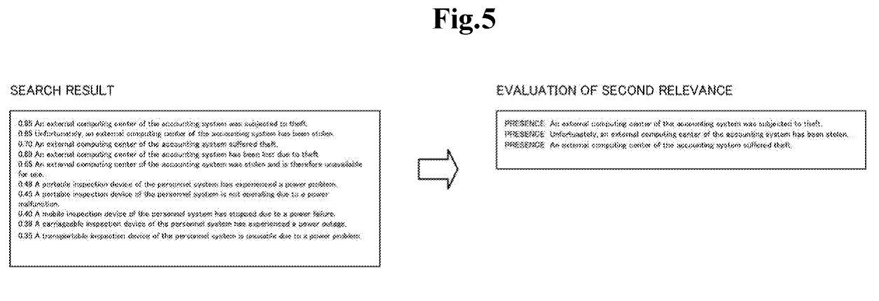

Here, in the example of FIG. 5, it is assumed that the number of pieces of candidate data for which the second relevance is to be evaluated is set to three, based on the content of the search query or on the settings of the user or the system. Accordingly, in the left drawing of FIG. 5, although ten pieces of candidate data are retrieved, only three pieces of the candidate data are subject to evaluation of the second relevance with respect to the search query. At this time, the selecting unit 12 determines the order of the pieces of candidate data in descending order of the similarity scores that are evaluation of the first relevance of the candidate data, and, in the determined order, the selecting unit 12 designates the top three pieces of candidate data as targets for evaluation of the second relevance. As a result, as shown in the right side of FIG. 3, the second relevance is evaluated only for the top three pieces of candidate data in terms of similarity score. As a result, the user is able to promptly obtain presentation data that appropriately corresponds to the search query.

### Third Example Embodiment

Next, a third example embodiment of the present disclosure will be described with reference to the drawings. Noted that the drawings may be relevant to any of the example embodiments.

An information processing apparatus 10 according to this example embodiment has the same configuration as that of the first example embodiment described above. In addition, the information processing apparatus 10 has the following configuration. The following mainly describes a configuration that differs from the above.

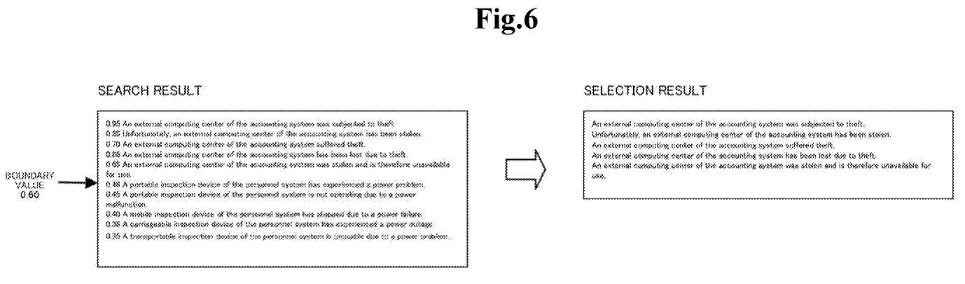

In this example embodiment, the selecting unit 12 of the information processing apparatus 10 does not necessarily evaluate the second relevance between the search query and the candidate data. Specifically, when a boundary value of the similarity score that is an evaluation of the first relevance in the candidate data retrieved by the search unit 11 is set, the selecting unit 12 may select, as presentation data, pieces of candidate data whose similarity scores exceed the boundary value, without evaluating the second relevance for the candidate data. Note that the boundary value can be preset by the user or the system. As an example, when the boundary value is set to 0.60 as illustrated in FIG. 6, the selecting unit 12 selects, as presentation data, five pieces of candidate data whose similarity scores exceed the boundary value of 0.60.

Note that the above-described boundary value may be set based on the content of the text data serving as the search query. For example, the selecting unit 12 examines the content of the text data serving as the search query, and when the content is determined to be of high urgency according to the content, the selecting unit 12 sets a higher boundary value as the degree of urgency is higher. Then, the selecting unit 12 selects, as presentation data, pieces of the candidate data whose similarity scores exceed the boundary value, without evaluating the second relevance for the candidate data.

### Fourth Example Embodiment

Next, a fourth example embodiment of the present disclosure will be described with reference to the drawings. Noted that the drawings may be relevant to any of the example embodiments.

An information processing apparatus 10 according to this example embodiment has the same configuration as that of the first to third example embodiments described above. In this example embodiment, the content of data that is searched for and presented by the user is different from that in the first to third example embodiments.

In this example embodiment, it is assumed that image data and audio data are stored in the database 20. As an example, image data is facial image data of a person, and audio data is voice data of a person. In this example embodiment, a user inputs, as a search query, data of the same type as the data stored in the database 20. For example, the user inputs, as a search query, image data such as facial image data or audio data such as voice data.

The information processing apparatus 10 evaluates a similarity score that is first relevance between the facial image data and the voice data input as the search query and the image data and the audio data in the database 20, and, in accordance with the evaluation result, searches for the image data and audio data in the database 20 and extracts them as candidate data. Note that evaluation of the similarity score between the pieces of image data or between the pieces of audio data can be implemented by existing techniques and may be performed using any method.

Subsequently, the information processing apparatus 10 evaluates presence or absence of second relevance, namely the relevance between the face image data and the voice data serving as the search query and the image data and the audio data serving as the candidate data, and selects presentation data from the candidate data. At this time, the information processing apparatus 10 requests the generative AI 30 to determine relevance is present or absent. The generative AI 30 is assumed to be a multimodal machine learning model capable of processing image data and audio data as well.

Then, the information processing apparatus 10 presents and outputs the selected presentation data to the user. As a result, the user can obtain, from the database 20, data that can appropriately correspond to the face image data and the voice data input as a search query, in such a manner that the number of pieces of candidate data is narrowed down. As a result, it is easier to select more appropriate data from the presentation data.

Note that in the present disclosure, the format of the data searched for and presented to the user is not limited to the above-described text data, image data, and audio data, and may be data in any format.

### Fifth Example Embodiment

Next, a fifth example embodiment of the present disclosure will be described with reference to the drawings. This example embodiment shows an outline of the information processing apparatus and the like described in the above example embodiments. Note that the drawings may be relevant to any of the example embodiments.

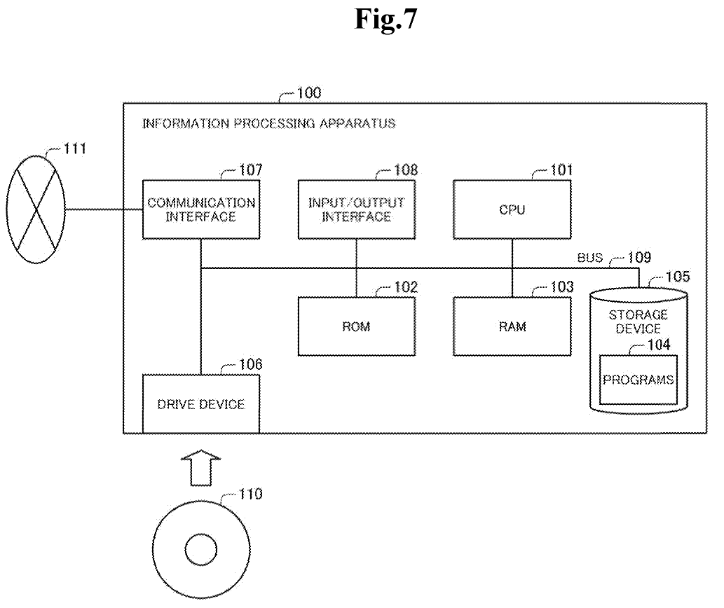

First, a hardware configuration of an information processing apparatus 100 according to the present disclosure will be described. The information processing apparatus 100 is configured of a general information processing apparatus and, as one example, is equipped with the following hardware configuration as illustrated in FIG. 7:
a CPU (Central Processing Unit) 101 (arithmetic logic unit);
a ROM (Read Only Memory) 102 (memory unit);
a RAM (Random Access Memory) 103 (memory unit);
programs 104 to be loaded into the RAM 103;
a storage device 105 storing the programs 104;
a drive device 106 that performs reading from and writing into a storage medium 110 external to the information processing apparatus;
a communication interface 107 that connects to a communication network 111 external to the information processing apparatus;
an input/output interface 108 that performs input/output of data;
and a bus 109 connecting the respective components.

FIG. 7 illustrates an example of a hardware configuration of an information processing apparatus serving as the information processing apparatus 100, and the hardware configuration of the information processing apparatus is not limited to the aforementioned case. For example, the information processing apparatus may be configured of part of the above-described components, such as not having the drive device 106. Moreover, the information processing apparatus may use a GPU (Graphic Processing Unit), a DSP (Digital Signal Processor), an MPU (Micro Processing Unit), an FPU (Floating point number Processing Unit), a PPU (Physics Processing Unit), a TPU (Tensor Processing Unit), a quantum processor, a microcontroller, or a combination thereof, instead of the aforementioned CPU.

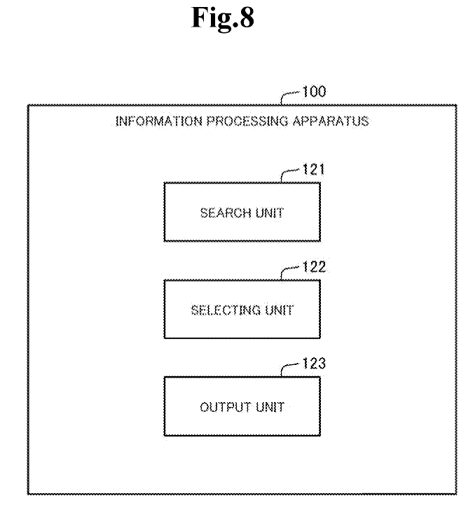

The information processing apparatus 100 can construct, and can be provided with, a search unit 121, a selecting unit 122, and an output unit 123 as illustrated in FIG. 8, by having the CPU 101 acquire the programs 104 and having the CPU 101 execute it. The programs 104 are, for example, stored in advance in the storage device 105 or the ROM 102, and are loaded into the RAM 103 and executed by the CPU 101 as necessary. In addition, the programs 104 may be provided to the CPU 101 via the communication network 111, or the programs may be stored in advance in the storage medium 110 and read out by the drive device 106 and provided to the CPU 101. However, the search unit 121, the selecting unit 122, and the output unit 123 described above may be constructed by dedicated electronic circuits for implementing such means.

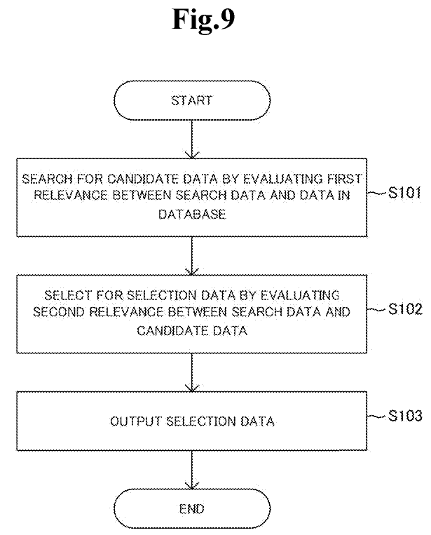

The search unit 121 searches for candidate data from the data in the database, on the basis of evaluation of first relevance between search data and the data stored in the database (step S101 in FIG. 9). The selecting unit 122 selects selection data from the candidate data, on the basis of evaluation of second relevance between the search data and the candidate data, the second relevance being different from the first relevance (step S102 in FIG. 9). The output unit 123 outputs the selection data (step S103 in FIG. 9).

In the above configuration, the information processing apparatus 100 first calculates, for example, similarity as evaluation of first relevance between search data provided by the user and the data stored in the database, and searches for candidate data from the data in the database on the basis of the evaluation. Then, as evaluation of second relevance between the search data and the candidate data, the information processing apparatus 100 acquires, for example, determination on presence or absence of relevance by a large language model, and selects selection data from the candidate data on the basis of the evaluation. Thereafter, the information processing apparatus 100 outputs the selection data to the user. As a result, the user can obtain selection data that appropriately corresponds to the search data. In particular, since the number of pieces of selection data is narrowed down, it is easier to select more appropriate data from the selection data.

Note that at least one of the functions among the search unit 121, the selecting unit 122, and the output unit 123 described above may be executed by an information processing apparatus that is installed and connected at any location on a network; that is to say, it may be executed using so‑called cloud computing.

The aforementioned programs can be stored using various types of non-transitory computer-readable media and provided to a computer. The non-transitory computer-readable media include various types of tangible storage media. Examples of non-transitory computer-readable media include magnetic recording media (e.g., flexible disks, magnetic tapes, hard disk drives), magneto-optical recording media (e.g., magneto-optical disks), read only memories (CD-ROMs), CD-Rs, CD-R/Ws, and semiconductor memories (e.g., mask ROMs, programmable ROMs, Erasable PROMs, flash ROMs, random access memories (RAMs)). In addition, the programs may be provided to a computer by various types of transitory computer-readable media. Examples of transitory computer-readable media include electrical signals, optical signals, and electromagnetic waves. The transitory computer-readable media may provide programs to a computer via wired communication channels such as an electric wire and an optical fiber or wireless communication channels.

The present disclosure has been described above with reference to example embodiments. However, the present disclosure is not limited to the example embodiments described above. The configuration and details of the present disclosure can be changed in a variety of ways that those skilled in the art can understand within the scope of the present disclosure. Each of the example embodiments described above can be combined with other example embodiments as appropriate.

### Supplementary Notes

The whole or part of the example embodiments disclosed above can be described as the following supplementary notes. Below, an overview of the configurations of an information processing apparatus, an information processing method, and a program according to the present disclosure will be described. However, the present disclosure is not limited to the configurations described in the following supplementary notes.

Note that some or all of the configurations described in Supplementary Notes 2 to 8.1, which are dependent on Supplementary Note 1, and the functions realized by these configurations, may similarly be made dependent on other Supplementary Notes 9 and 10 in the same dependent relationship as Supplementary Notes 2 to 8.1. Furthermore, not limited to Supplementary Notes 1, 9, and 10, within the scope not departing from the above-described embodiments, some or all of the configurations described as supplementary notes and the functions realized by these configurations may similarly be made dependent on similar hardware, software, various storage means for storing software, or systems.

### Supplementary Note 1

An information processing apparatus comprising:
a search unit that searches for candidate data from data in a database on a basis of evaluation of first relevance between search data and the data stored in the database;
a selecting unit that selects selection data from the candidate data on a basis of evaluation of second relevance between the search data and the candidate data, the second relevance being different from the first relevance; and
an output unit that outputs the selection data.

### Supplementary Note 2

The information processing apparatus according to supplementary note 1, wherein
the selecting unit determines a number of pieces of the candidate data on a basis of a content of the search data, and evaluates the second relevance between the determined number of pieces of the candidate data and the search data.

### Supplementary Note 3

The information processing apparatus according to supplementary note 2, wherein
the selecting unit determines order of the pieces of candidate data on the basis of the evaluation of the first relevance, and evaluates the second relevance between the determined number of pieces of the candidate data in the determined order and the search data.

### Supplementary Note 4

The information processing apparatus according to supplementary note 1, wherein
the selecting unit determines order of pieces of the candidate data on the basis of the evaluation of the first relevance, and evaluates the second relevance between a preset number of pieces of the candidate data in the determined order and the search data.

### Supplementary Note 5

The information processing apparatus according to supplementary note 1, wherein
the search unit evaluates the first relevance using a continuous value, and
the selecting unit determines, on a basis of the evaluation of the second relevance, a boundary value of the evaluation of the first relevance, the boundary value representing a boundary as to whether or not to select the selection data from the candidate data.

### Supplementary Note 6

The information processing apparatus according to supplementary note 1, wherein
the search unit evaluates the first relevance on a basis of similarity between the search data and the data in the database, and
the selecting unit evaluates the second relevance on a basis of a possibility that the search data and the candidate data form a pair.

### Supplementary Note 7

The information processing apparatus according to supplementary note 6, wherein
the selecting unit evaluates the second relevance on a basis of determination by a model that evaluates the possibility that the search data and the candidate data form a pair.

### Supplementary Note 8

The information processing apparatus according to supplementary note 1, wherein
the search unit evaluates the first relevance in using a continuous value, and
when a boundary value of the evaluation of the first relevance is set, the boundary value representing a boundary as to whether or not to select the selection data from the candidate data, the selecting unit selects the selection data from the candidate data on a basis of the boundary value without performing evaluation of the second relevance.

### Supplementary Note 8.1

The information processing apparatus according to supplementary note 8, wherein
the selecting unit sets the boundary value on a basis of a content of the search data.

### Supplementary Note 9

An information processing method comprising, by an information processing apparatus:
searching for candidate data from data stored in a database on a basis of evaluation of first relevance between search data and the data stored in the database;
selecting selection data from the candidate data on a basis of evaluation of second relevance between the search data and the candidate data, the second relevance being different from the first relevance;
outputting the selection data.

### Supplementary Note 10

A program for causing an information processing apparatus to execute processing to:
search for candidate data from data stored in a database on a basis of evaluation of first relevance between search data and the data stored in the database;
select selection data from the candidate data on a basis of evaluation of second relevance between the search data and the candidate data,
the second relevance being different from the first relevance; and
output the selection data.

1. An information processing apparatus comprising:
at least one memory configured to store instructions; and
at least one processor configured to execute the instructions to:
search for candidate data from data in a database on a basis of evaluation of first relevance between search data and the data stored in the database;
select selection data from the candidate data on a basis of evaluation of second relevance between the search data and the candidate data, the second relevance being different from the first relevance; and
output the selection data.

2. The information processing apparatus according to claim 1, wherein the at least one processor is configured to execute the instructions to
determine a number of pieces of the candidate data on a basis of a content of the search data, and evaluate the second relevance between the determined number of pieces of the candidate data and the search data.

3. The information processing apparatus according to claim 2, wherein the at least one processor is configured to execute the instructions to
determine order of the pieces of the candidate data on the basis of the evaluation of the first relevance, and evaluates the second relevance between the determined number of pieces of the candidate data in the determined order and the search data.

4. The information processing apparatus according to claim 1, wherein the at least one processor is configured to execute the instructions to
determine order of pieces of the candidate data on the basis of the evaluation of the first relevance, and evaluates the second relevance between a preset number of pieces of the candidate data in the determined order and the search data.

5. The information processing apparatus according to claim 1, wherein the at least one processor is configured to execute the instructions to:
evaluate the first relevance using a continuous value; and
determine, on the basis of the evaluation of the second relevance, a boundary value of the evaluation of the first relevance, the boundary value representing a boundary as to whether or not to select the selection data from the candidate data.

6. The information processing apparatus according to claim 1, wherein the at least one processor is configured to execute the instructions to:
evaluate the first relevance on a basis of similarity between the search data and the data in the database; and
evaluate the second relevance on a basis of a possibility that the search data and the candidate data form a pair.

7. The information processing apparatus according to claim 6, wherein the at least one processor is configured to execute the instructions to
evaluate the second relevance on a basis of determination by a model that evaluates the possibility that the search data and the candidate data form a pair.

8. The information processing apparatus according to claim 1, wherein the at least one processor is configured to execute the instructions to:
evaluate the first relevance using a continuous value; and
when a boundary value of the evaluation of the first relevance is set, the boundary value representing a boundary as to whether or not to select the selection data from the candidate data, select the selection data from the candidate data on a basis of the boundary value without performing evaluation of the second relevance.

9. The information processing apparatus according to claim 8, wherein the at least one processor is configured to execute the instructions to
set the boundary value on a basis of a content of the search data.

10. An information processing method comprising, by an information processing apparatus:
searching for candidate data from data in a database on a basis of evaluation of first relevance between search data and the data stored in the database;
selecting selection data from the candidate data on a basis of evaluation of second relevance between the search data and the candidate data, the second relevance being different from the first relevance; and
outputting the selection data.

11. The information processing method according to claim 10, further comprising, by the information processing apparatus,
determining a number of pieces of the candidate data on a basis of a content of the search data, and evaluating the second relevance between the determined number of pieces of the candidate data and the search data.

12. The information processing method according to claim 11, further comprising, by the information processing apparatus,
determining order of the pieces of the candidate data on the basis of the evaluation of the first relevance, and evaluating the second relevance between the determined number of pieces of the candidate data in the determined order and the search data.

13. The information processing method according to claim 10, further comprising, by the information processing apparatus,
determining order of pieces of the candidate data on the basis of the evaluation of the first relevance, and evaluating the second relevance between a preset number of pieces of the candidate data in the determined order and the search data.

14. The information processing method according to claim 10, further comprising, by the information processing apparatus:
evaluating the first relevance using a continuous value; and
determining, on the basis of the evaluation of the second relevance, a boundary value of the evaluation of the first relevance, the boundary value representing a boundary as to whether or not to select the selection data from the candidate data.

15. The information processing method according to claim 10, further comprising, by the information processing apparatus:
evaluating the first relevance on a basis of similarity between the search data and the data in the database; and
evaluating the second relevance on a basis of a possibility that the search data and the candidate data form a pair.

16. The information processing method according to claim 15, further comprising, by the information processing apparatus,
evaluating the second relevance on a basis of determination by a model that evaluates the possibility that the search data and the candidate data form a pair.

17. The information processing method according to claim 10, further comprising, by the information processing apparatus:
evaluating the first relevance using a continuous value; and
when a boundary value of the evaluation of the first relevance is set, the boundary value representing a boundary as to whether or not to select the selection data from the candidate data, selecting the selection data from the candidate data on a basis of the boundary value without performing evaluation of the second relevance.

18. The information processing method according to claim 17, further comprising, by the information processing apparatus,
setting the boundary value on a basis of a content of the search data.

19. A non-transitory computer-readable storage medium storing thereon a program comprising instructions for causing an information processing apparatus to execute processing to:
search for candidate data from data in a database on a basis of evaluation of first relevance between search data and the data stored in the database;
select selection data from the candidate data on a basis of evaluation of second relevance between the search data and the candidate data, the second relevance being different from the first relevance; and
output the selection data.
